(19) United States
(12) Patent Application Publication
(10) Pub. No.: US 2017/0179700 A1
(43) Pub. Date: Jun. 22, 2017

(54) MOUNTING FOR ELECTRICAL JUNCTION BOX IN A CINDERBLOCK WALL

(71) Applicants: DAVID K. TATE, ALACHUA, FL (US); MATTHEW J. TATE, GAINSEVILLE, FL (US)

(72) Inventors: DAVID K. TATE, ALACHUA, FL (US); MATTHEW J. TATE, GAINSEVILLE, FL (US)

(21) Appl. No.: 15/387,545

(22) Filed: Dec. 21, 2016

Related U.S. Application Data
(60) Provisional application No. 62/387,071, filed on Dec. 22, 2015.

(51) Int. Cl. H02G 3/06; H02G 3/08; F16M 13/02; H02G 3/04

(52) U.S. Cl. CPC H02G 3/0616; H02G 3/0481; H02G 3/083; F16M 13/02

(57) ABSTRACT

A wedge member for securing an electrical conductor box within a hollow concrete block which is to be incorporated in a concrete block wall. The wedge member includes an elongated member dimensioned for a force fit within a hole within the concrete block.

### CROSS-REFERENCE TO RELATED APPLICATIONS

This application claims the benefit of United States provisional application 62/387,071, confirmation number 1985, filed on Dec. 22, 2015 having the same inventors as the present application.

### TECHNICAL FIELD

The present invention is generally directed to apparatus for mounting an electrical junction box. Electrical junction boxes or containers for electrical connections, usually intended to conceal them from site in deter tempering as well as to prevent inadvertent touching of wires and connections for wires that would otherwise present a danger. More particularly, the present invention is directed to mounting a junction box in a cinderblock wall.

### BACKGROUND OF THE INVENTION

Historically electrical junction boxes have been arbitrarily placed in a hole in a cinderblock that is part of a cinderblock wall utilizing chunks of concrete or scrap wood in an attempt to prevent movement of the junction box. Often such mountings resulted in junction boxes not being securely mounted as initially installed and/or not being securely mounted after the elapse of some time. Instability of the junction box is unsatisfactory because it does not present a workmanlike installation appearance and may even present safety hazards.

From the above, it is therefore seen that there exists a need in the art to overcome the deficiencies and limitations described herein and above.

### SUMMARY OF THE INVENTION

Accordingly, it is an object of the present invention to provide a mounting apparatus for a junction box within a cinderblock to be incorporated in the cinderblock wall that insures both good workmanship as well as a safe installation.

It is another object of the present invention to provide apparatus that can be employed rapidly.

It is yet another object of the present invention to provide apparatus that is inexpensive to manufacture.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

The shortcomings of the prior art are overcome and additional advantages are provided through a wedge member for securing an electrical conductor box within a hollow concrete block which is to be incorporated in a concrete block wall which includes an elongated member having first and second axial extremities, the elongated member having a substantially uniform diameter throughout the axial extent thereof.

The first axial extremity includes a first stop that prevents axial movement through a hole of an associated electrical conductor box. A second stop is axially spaced from the first stop a distance that is substantially equal to the thickness of an associated electrical conductor box. The second stop is disposed closer to the second axial extremity of the elongated member than the first stop. The second stop includes at least one inclined ramp generally aligned with the geometric axis of the elongated member. The inclined ramp has a first end substantially coincident with the substantially uniform diameter of the elongated member. The inclined ramp has a second end extending outside of the substantially uniform diameter of the elongated member whereby a step shaped surface is defined, the second end of the inclined ramp is closer to the first stop than to the first end of the inclined ramp. The elongated member is dimensioned whereby axial movement of the second axial extremity into the hole of an associated electrical conductor box followed by continued axial movement results in the wall of the associated electrical conductor box passing over the inclined ramp and locking the wall of the electrical conductor box intermediate the first stop and the second stop.

The wedge member may have a length that is dimensioned and configured to provide a force fit within a hole within an associated concrete block intermediate an electrical conductor box and an opposed wall of the hole in the associated concrete block.

The wedge member may be manufactured by injection molding process and may be a monolithic structure.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a partially schematic top view of a cinderblock in which a junction block is secured by the apparatus of the present invention within the interior of the cinderblock and further illustrating a plaster ring extending through the wall of the cinderblock to allow access to the interior the junction box after the cinderblock is placed in one of the courses of cinderblocks in a cinderblock wall.

FIG. 2 is an isometric view of a junction box connected to one embodiment of the present invention prior to installation within a cinderblock,

FIG. 3 is an isometric view of a junction box connected to the same embodiment of the present invention prior to installation within a cinderblock,

FIG. 4 is an isometric view of a first side of one embodiment of the wedge member apparatus in accordance with the present invention, and

FIG. 5. is a partial isometric view showing a second side of the wedge member embodiment illustrated in FIG. 4 in greater detail.

### DETAILED DESCRIPTION

The term “concrete block” as used herein will be understood to refer to concrete masonry and its alternatives. Commonly, such box are casting wooden molds use a mix of powdered limestone and clay mixed with water. Such blocks our commonly used for foundation walls, cavity walls, monolithic walls, partition walls, separating walls and of the commodity beam and block flooring. Such blocks offer strength as well as insulating and sound reducing properties. Typically, dense aggregate blocks are manufactured from cement, sand and aggregates. Other blocks known as lightweight aggregate blocks are a strong and used in both internal and external walls. Lightweight blocks are manufactured from cement together with one of a variety of natural or man-made expanded aggregates including: granulated/foamed blast-furnace slide, expanding clay or shale, furnace bottom mash, pulverized fuel or the less common pumice (a volcanic material). Other concrete blocks are referred to as aerated concrete blocks. The present invention has application to all such blocks as well as other variations thereof.

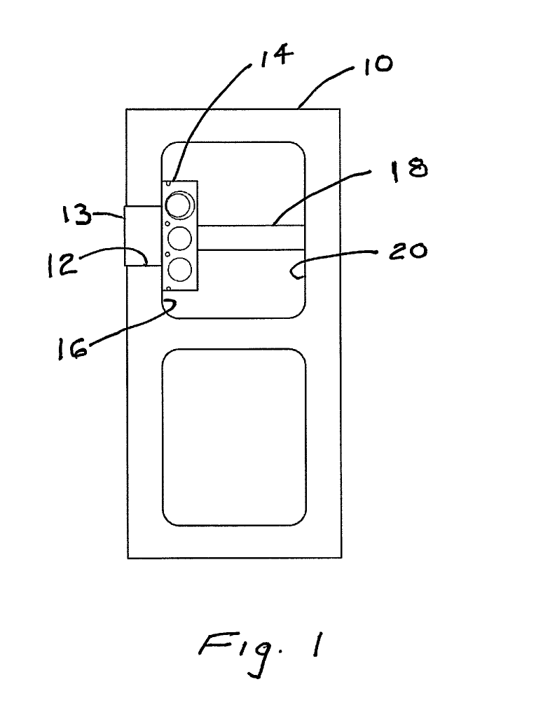

As described above it is difficult to position an electrical junction box within a wall made from so-called “concrete blocks.” As best seen in FIG. 1 an individual concrete block 10 before being made part of a concrete block wall has a hole 12 formed in a first side wall 16 thereof. The hole may be formed by masonry chisel or other techniques. Thereafter, an electrical junction box 14 having an open face and a closed face is wedged in place with the open face surrounding the hole 12 wall of the concrete block. A wedge member 18 in accordance with the present invention is elongated and has a first axial extremity that engages a closed face of the electrical junction box 14 as well as a second axial extremity that firmly abuts a second side wall 20 disposed in opposed relationship to the first side wall 16. A conventional plaster ring 13 extends through the wall of the concrete block 10. Those skilled in the art will recognize the plaster ring is an extension for recessed electrical box made of steel or plastic which has face edges that are flush with the surface of the wall.

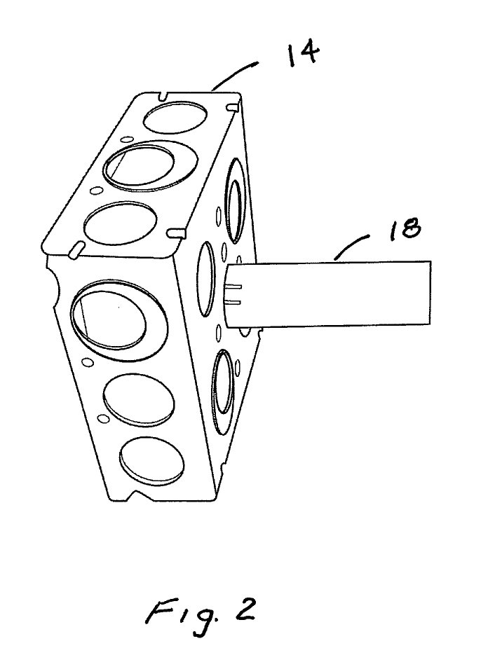

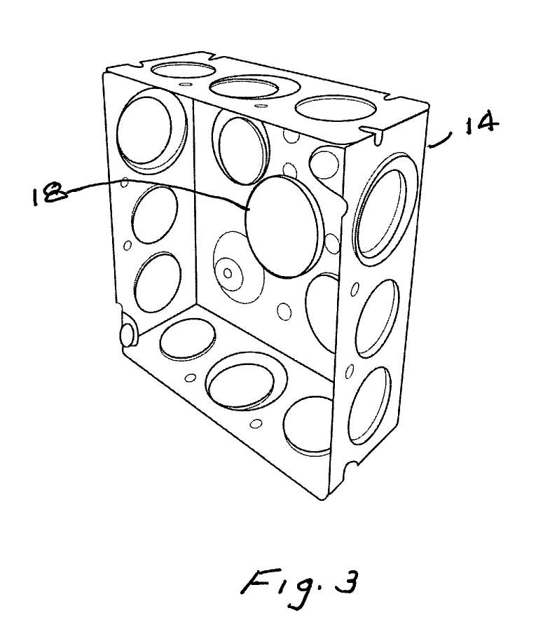

The relationship between the electrical junction box 14 and the wedge member 18 is shown in greater detail in FIG. 2 as well as FIG. 3. As shown more clearly in these figures the electrical junction box has a plurality of knock outs to facilitate installation of wire connections at any of a plurality of sides or the back thereof. Ordinarily, the closed back of the box will have a centrally located knock out. Normal utilization of the wedge member 18 will engage the wedge member 18 with the hole that is accessible when the centrally located knock out in the back of the electrical junction box is punched out.

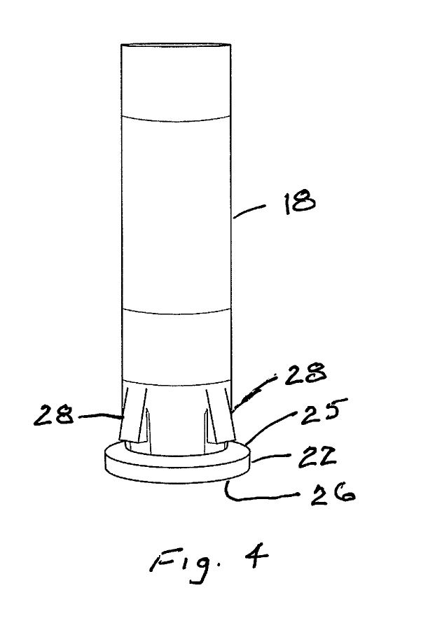

The construction of one embodiment of the wedge member 18 in accordance with the present invention is apparent from FIG. 4. The first axial extremity, which is the bottom end as viewed, engages the knock out of the electrical conductor box 14. The wedge member 18 is ordinarily injection molded as a single piece. Although the wedge member 18 is ordinarily a single piece the description of the contours thereof will refer to individual contours thereof in a manner which might be misconstrued as constituting discrete parts. More specifically, the illustrated embodiment does not include discrete parts although embodiments of the present invention might be manufactured in that manner.

The lowest part as viewed of the wedge member 18 it is a lip or ring shaped member 22 which may also be referred to herein as a first stop. The ring-shaped member 22 has a planar upper face 25 and a planar bottom face 26. The planar upper face 25 in the planar bottom face 26 are parallel and perpendicular to the geometric axis of the wedge member 18. It will be understood that the view of the apparatus in accordance with one form of the present invention shown in FIG. 3 is marked as showing the wedge member 18. It will be understood that the visible part of the wedge member 18 in FIG. 3 is more specifically the planar bottom face 26.

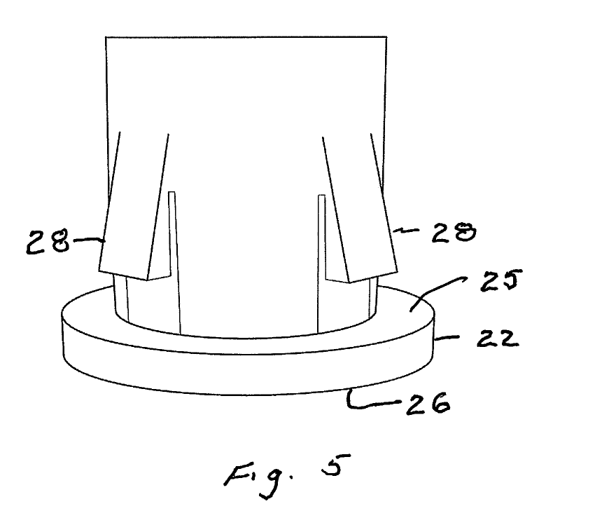

In the illustrated embodiment of the present invention the wedge member 18 further includes four fingers (two visible in Figure. 4 as well as two more visible in FIG. 5) that are sufficiently flexible whereby the wedge member 18 can be installed in the hole remaining after removal of a knock out by inserting the second axial extremity (the upper end as viewed in FIG. 4) into the open face of the electrical conductor box 14 and specifically into the hole where the knock out was removed. The wedge member 18 is dimensioned and configured whereby when substantially the entire axial extent thereof has passed through the whole the fingers 28 will be compressed sufficiently to allow placement of the wall of the electrical conductor box firmly seated intermediate the fingers 28 and the planar upper face 25. Accordingly, the discussion herein may referred to the planar upper face 25 as a first stop and the face of the fingers 28 abutting the wall of the electrical conductor box 14 may be referred to as a second stop.

The illustrated embodiment utilizes a plurality of fingers 28 that are dimensioned and configured to allow passage of the wedge member through the hole left after the removal of a knock out as well as locking engagement accomplished with the fingers 28. Other embodiments of the present invention may alternatively utilize a lip that is (1) continuous lip extending around the entire periphery of the wedge member or (2) at peripheral parts of the periphery to achieve the same locking relationship with respect to the wall of the electrical conductor box 14.

It will be understood that the required clamping action between the wedge member 18 and the wall of the electrical conductor box 14 could be achieved, for example, with helical screw threads on the peripheral surface of the wedge member and they cooperating internally threaded nut to secure the wedge member to the electrical conductor box. The present invention relies on fingers 28 or equivalent projections that are dimensioned and configured to pass through the hole left when the knockout is removed and then lock in place. Advantageously the ramp shaped fingers facilitate sliding axial movement followed by locking engagement of the wedge member with respect to the electrical conductor box. Preferably, the fingers/wedge members have some flexibility to facilitate the sliding axial movement followed by locking engagement.

Ordinarily, the illustrated embodiment of the present invention will be manufactured by an injection molding process as a single piece.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference. Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

what is claimed is:

1. A wedge member for securing an electrical conductor box within a hollow concrete block which is to be incorporated in a concrete block wall which comprises:
an elongated member having first and second axial extremities, said elongated member having a substantially uniform diameter throughout the axial extent thereof
said first axial extremity including a first stop that prevents axial movement through a hole of an associated electrical conductor box;
a second stop that is axially spaced from said first stop a distance substantially equal to the thickness of the associated electrical conductor box, said second stop being disposed closer to said second axial extremity of said elongated member than said first stop, said second stop including at least one inclined ramp generally aligned with the geometric axis of the elongated member, said inclined ramp having a first end substantially coincident with said substantially uniform diameter of said elongated member, said inclined ramp having a second end extending outside of said substantially uniform diameter of the elongated member whereby a step shaped surface is defined, said second end of said inclined ramp being closer to said first stop than to said first end of said inclined ramp, said elongated member being dimensioned whereby axial movement of said second axial extremity into the hole of an associated electrical conductor box followed by continued axial movement results in the wall of the associated electrical conductor box passing over the inclined ramp and locking the wall of the electrical conductor box intermediate said first stop and said second stop.

2. The wedge member as described in claim 1 wherein said elongated member has a length that is dimensioned and configured to provide a force fit within a hole within an associated concrete block intermediate an electrical conductor box and an opposed wall of the hole in the associated concrete block.

3. The wedge member as described in claim 1 wherein said wedge member is manufactured by injection molding process.

4. The wedge member as described in claim 2 wherein said wedge member is manufactured by injection molding process.

5. The wedge member as described in claim 1 wherein said wedge member is a monolithic structure.
